(19) United States
(12) Patent Application Publication
(10) Pub. No.: US 2026/0351501 A1
(43) Pub. Date: Nov. 5, 2026

(54) TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 19/659,155

(22) Filed: Apr. 27, 2026

(30) Foreign Application Priority Data
Apr. 30, 2025 (DE) 10 2025 116 806.7

(51) Int. Cl. H01H 37/54; H01H 37/68

(52) U.S. Cl. CPC H01H 37/5427; H01H 37/5418; H01H 37/68; H01H 2037/5454

(57) ABSTRACT

A temperature-dependent switch comprising a cup-shaped or pocket-shaped switch housing made of metal with an open housing side, a temperature-dependent switching mechanism, which is arranged in the switch housing, and an insulating body that carries the temperature-dependent switching mechanism and electrically insulates a first terminal strip from a second terminal strip of the temperature-dependent switching mechanism. The insulating body is inserted into the switch housing together with the temperature-dependent switching mechanism. The insulating body comprises a first through-opening, through which the first electrical connection lead extends, as well as a second through-opening through which the second electrical connection lead extends. The open housing side of the switch housing is gas-tightly sealed with a filler material, through which each of a first electrical connection lead and a second electrical connection lead of the switch extends, respectively.

### CROSS-REFERENCE TO RELATED APPLICATIONS

This application claims priority from German patent application DE 10 2025 116 806.7 filed on Apr. 30, 2025. The entire content of this priority application is incorporated herein by reference.

### FIELD

This disclosure relates to a temperature-dependent switch.

An exemplary temperature-dependent switch is disclosed in EP 0 103 792 B1.

Such temperature-dependent switches serve, in a manner known in the art, to monitor the temperature of a device. For this purpose, the switch is brought into direct or indirect thermal contact with the device to be protected, so that the temperature of the device to be protected influences the temperature of the switching mechanism arranged in the interior of the switch.

The switch is typically connected electrically in series into the power supply circuit of the device to be protected via connection leads, so that below the response temperature of the switch, the supply current of the device to be protected flows through the switch.

Such temperature-dependent switches include a temperature-dependent switching mechanism, which is encapsulated in a switch housing and which, depending on its temperature, opens or closes an electrically conductive connection between the two electrical terminals of the switch. More precisely, the temperature-dependent switching mechanism is configured to switch in a temperature-dependent manner between a closed state, in which the switching mechanism establishes the electrically conductive connection between the two electrical terminals of the switch, and an open state, in which the switching mechanism disconnects the electrically conductive connection between the two electrical terminals of the switch.

The switching behavior, i.e., the switching between the closed state and the open state, occurs in a temperature-dependent manner. For the temperature-dependent switching behavior of the switching mechanism, a bimetal element is typically responsible, which, in a known manner, switches or snaps in a temperature-dependent manner in the manner of a hysteresis between two configurations, a low-temperature configuration or a low-temperature position and a high-temperature configuration or a high-temperature position.

In the switch disclosed in EP 0 103 792 B1, the two electrical connection leads are connected in the interior of the switch to a respective terminal strip, which projects freely into the interior of the switch housing and in each case has a contact element in a region of its free end projecting into the switch. In the closed state of the switching mechanism, the two contact elements touch each other. In the open state, the two contact elements are lifted from one another, i.e., separated from one another, so that the electrical circuit is opened.

One of the two terminal strips comprises a bimetal or is made of bimetal. The other of the two terminal strips is made of a “conventional” metal and acts as a type of spring element. In this design of the temperature-dependent switching mechanism, the bimetal element and the spring element are thus connected in series mechanically and electrically in the closed state of the switching mechanism. The bimetal element is thus live. Accordingly, this design of the temperature-dependent switching mechanism leads to the switching mechanism not only switching in a temperature-dependent manner, but also in a current-dependent manner. Namely, an excessively high current leads to heating of the bimetal element due to the electrical resistance, so that it also snaps into its high-temperature configuration upon exceeding a certain maximum current value.

Thus, if the temperature of the bimetal element increases as a result of a temperature increase in the device to be protected or as a result of a high electrical current above a defined temperature, which is referred to as the response temperature or switching temperature of the bimetal element, the bimetal element snaps from its low-temperature configuration into its high-temperature configuration and thus causes a switching operation from the closed state to the open state or vice versa. Depending on the installation of the bimetal element, the temperature-dependent switching mechanism can be designed such that it is in the closed state below the response or switching temperature of the bimetal element, which is referred to as “normally closed”, or instead is then in the open state, which is typically referred to as “normally open”.

In the switch disclosed in EP 0 103 792 B1, the temperature-dependent switching mechanism is held by an insulating body, which is inserted together with the switching mechanism into the switch housing. This insulating body is made of injection-molded material and, due to the tight holding dimensions it must fulfill for a stable mounting of the switching mechanism, must necessarily be made of plastic. However, this limits the subsequent processing measures, such as sealing the switch housing, to relatively low temperatures in order to prevent melting of the insulating body. Furthermore, the design of the known temperature-dependent switch requires a casing made of insulating material, since the electrical connection leads are guided out between the insulating body and the switch housing. A casing made of insulating material, however, limits the heat transfer and thus the response sensitivity of the switch to ambient temperature. Furthermore, a design of the switch housing made of plastic is associated with an insufficient mechanical pressure resistance of the switch housing. Moreover, with a switch housing made of plastic, only a limited gas-tight sealing of the switch housing can be achieved.

### SUMMARY

It is an object to provide a temperature-dependent switch which overcomes the above-mentioned disadvantages or at least largely eliminates them. In particular, it is an object to provide for increased pressure resistance of the switch housing, improved thermal coupling, and improved sealing of the switch housing.

According to an aspect, a temperature-dependent switch is presented comprising: a switch housing formed of metal and having a cup-shaped or pocket-shaped configuration, the switch housing defining an open housing side; a first electrical connection lead extending from the switch housing; a second electrical connection lead extending from the switch housing; a temperature-dependent switching mechanism disposed in the switch housing and configured to switch in a temperature-dependent manner between a closed state, in which the switching mechanism establishes an electrically conductive connection between the first electrical connection lead and the second electrical connection lead, and an open state, in which the switching mechanism interrupts the electrically conductive connection, the temperature-dependent switching mechanism comprising: a first terminal strip connected to or integrally formed with the first electrical connection lead, the first terminal strip having a free end extending into an interior of the switch housing and carrying a first contact element, and a second terminal strip connected to or integrally formed with the second electrical connection lead, the second terminal strip having a free end extending into the interior of the switch housing and carrying a second contact element, wherein the second contact element is biased into contact with the first contact element in the closed state and is spaced apart from the first contact element in the open state; an insulating body supporting the temperature-dependent switching mechanism and electrically insulating the first terminal strip from the second terminal strip, the insulating body being disposed in the switch housing, the insulating body including: a first through-opening through which the first electrical connection lead extends, and a second through-opening through which the second electrical connection lead extends; and a filler material sealing the open housing side of the switch housing in a gas-tight manner, wherein the first electrical connection lead and the second electrical connection lead extend through the filler material.

The temperature-dependent switching mechanism of the switch has a somewhat similar structure as is already known from EP 0 103 792 B1. Both contact elements are movably mounted in the interior of the switch housing. In the closed state of the switch, the first terminal strip, on which the first contact element is arranged, and the second terminal strip, on which the second contact element is arranged, are mechanically and electrically connected in series. The first terminal strip preferably comprises a bimetal or is made of bimetal. In this respect, the switch is therefore also a temperature-dependent as well as current-dependent switch.

A design of the switch housing made of metal was not possible in the switch disclosed in EP 0 103 792 B1, since here the connection leads, due to the design, must necessarily be guided out between the switch housing and the insulating body. A design of the switch housing made of metal would thus have led to an electrical short circuit.

In the herein presented switch, this design of the switch housing made of metal is now possible, however, since two through-openings are provided in the insulating body, through which the electrical connection leads are guided through the insulating body, and since the open housing side of the switch housing is gas-tightly sealed with a filler material and the connection leads are each guided through this filler material. The filler material thus provides, on the one hand, a gas-tight sealing of the open housing side of the switch housing and, on the other hand, a mechanical stabilization of the connection leads in order to minimize the risk of the connection leads breaking off. Likewise, the filler material provides for an electrical insulation of the two connection leads from each other.

The design of the switch housing made of metal improves the thermal coupling of the switch. Moreover, this increases the pressure resistance by a multiple compared to a switch housing made of plastic. Ultimately, the gas-tightness of the switch is also enormously improved, which is not only due to the design of the switch housing made of metal, but also to the gas-tight sealing by the filler material, which closes the open housing side of the switch housing.

In a refinement, the filler material comprises a glass layer of fused glass.

Such a sealing by means of fused glass enables a hermetically gas-tight sealing of the switch housing. In particular, the glass-to-metal bond between the switch housing and the filler material can be designed to be hermetically gas-tight, so that this bond meets the requirements of DIN EN 60079-15. According to this, a hermetically sealed connection or a hermetically sealed device is understood to be a connection/device which is constructed in such a way that it cannot be opened and which is so effectively sealed by fusion that the ingress of external atmosphere is prevented. Preferably, such a hermetic glass-to-metal bond enables a vacuum-tight sealing of the switch housing. “Hermetic” or “hermetically sealed” is understood herein to mean a hermetic connection or a hermetic seal that prevents a substance exchange from the inside to the outside and from the outside to the inside. Typically, such hermetic seals have a leak rate of less than 1*10⁻⁷ mbar l/s, determined by means of a helium leak detector. achieving such a hermetically sealed device/connection according to DIN EN 60079-15 is generally only achieved by fusing metal to metal or glass to metal or glass to ceramic. Such a hermetic sealing would not be possible at all with the switch known from EP 0 103 792 B1, in which the switch housing is made of plastic.

In a further refinement, the insulating body is made of ceramic.

Ceramic is significantly more heat-resistant than plastic. In this respect, the filler material of fused glass can also be applied directly to the insulating body. Between the insulating body and the fused glass, a glass-to-ceramic bond is formed, which can also be designed to be hermetically gas-tight. In this respect, for the design of the insulating body made of ceramic, the gas-tightness of the switch can be improved overall. Furthermore, ceramic also has a higher hardness than plastic, whereby the pressure resistance of the switch is improved overall.

In a further refinement, the insulating body is arranged in a positive-locking manner in the switch housing and closes the open housing side of the switch housing.

This also improves, on the one hand, the pressure resistance of the switch and, on the other hand, facilitates the sealing of the switch housing.

In a further refinement, the filler material joins the insulating body to the switch housing in a materially bonded manner.

According to this refinement, the filler material thus provides not only for a sealing and gas-tight sealing of the switch housing, but at the same time also for a fixing of the insulating body and its connection to the switch housing. Between the insulating body and the fused glass, a ceramic-glass bond is thus formed. Between the switch housing and the fused glass, a metal-to-glass bond is formed. Both bonds can be designed to be hermetically gas-tight.

In a further refinement, the switch housing and the insulating body together form a cup-shaped recess into which the filler material is introduced.

In this refinement, the switch housing forms the peripheral wall of the cup-shaped recess and the insulating body forms the bottom of the cup-shaped recess. This refinement facilitates, in particular during the manufacture of the switch, the filling of the filler material in molten form and provides for a defined shape of the filler material in the solid state.

In a further refinement, the insulating body comprises a base section, which rests in a positive-locking manner against an inner wall of the switch housing, and a cantilever section, which protrudes from the base section in the manner of a cantilever beam and projects freely into the interior of the switch housing, wherein the first terminal strip is arranged on a first side of the cantilever section and the second terminal strip is arranged on a second side of the cantilever section opposite the first side.

The base section, resting against the inner wall of the switch housing in a materially bonded manner, provides for a sufficient hold or a sufficient fixing of the insulating body, which makes it possible to carry the cantilever section of the insulating body, which projects freely into the interior of the switch housing as a cantilever beam, without further ado. The cantilever section serves in particular for the separation and thus the electrical insulation of the two terminal strips from each other.

Preferably, the cantilever section comprises a guide groove in which the second terminal strip is arranged in a positive-locking manner.

This ensures in particular a stable mounting of the second terminal strip. The guide groove prevents the second terminal strip from shifting relative to the insulating body, which under certain circumstances could also impair the electrical contacting of the two contact elements in the closed state.

In a further refinement, the first terminal strip with its front end, which is projecting freely into the switch housing and on which the first contact element is arranged, projects over a front end of the cantilever section facing away from the base section. Likewise, the second terminal strip with its front end, which is projecting freely into the switch housing and on which the second contact element is arranged, projects over the front end of the cantilever section.

The cantilever section separates the two terminal strips from each other, in other words, but at the same time allows the contacting of the first contact element with the second contact element in the closed state of the switching mechanism. The insulating body thus provides for good electrical shielding of the two terminal strips from each other in the closed state of the switching mechanism.

In a further refinement, the first terminal strip comprises a bimetal, in particular the first terminal strip is constructed from a bimetal.

This refinement ensures in particular that the temperature-dependent switching mechanism not only switches temperature-dependently between the closed state and the open state, but also switches current-dependently between the closed state and the open state.

Particularly preferably, the first terminal strip made of bimetal is joined to the first electrical connection lead in a materially bonded manner. For example, the first terminal strip made of bimetal is soldered to the first electrical connection lead.

The second terminal strip is preferably made of conventional metal and is particularly preferably connected monolithically or integrally with the second connection lead.

In a further refinement, the insulating body comprises a first receiving pocket, in which a first spring element is arranged, which resiliently clamps the first terminal strip and/or the first electrical connection lead to the insulating body, and wherein the insulating body comprises a second receiving pocket, in which a second spring element is arranged, which resiliently clamps the second terminal strip and/or the second electrical connection lead to the insulating body.

This refinement improves the mechanical stability of the temperature-dependent switching mechanism. In particular, this prevents the terminal strips and/or the connection leads from shifting relative to the insulating body. At the same time, the contact pressure between the two contact elements in the closed state of the switch can be improved by the two spring elements.

In a further refinement, an inner wall of the switch housing facing the temperature-dependent switching mechanism is at least partially lined with a layer of electrically insulating material.

Here, it is particularly preferred that the layer of electrically insulating material is formed by an insulating cap, which is arranged clamped between the switch housing and the insulating body.

Such an insulating cap can be very easily inserted into the switch housing during the manufacture of the switch, before the temperature-dependent switching mechanism is inserted into the switch housing together with the insulating body. Since the insulating cap is clamped between the switch housing and the insulating body, it is thus also automatically fixed in its position. The insulating cap or the layer of electrically insulating material provides sufficient electrical shielding between the metal switch housing and the two electrical terminal strips. This particularly prevents short circuits in the open state of the switch, in which the first terminal strip typically comes very close to the inner wall of the switch housing. With the help of the insulating cap or the lining with electrically insulating material, a more compact design of the switch housing can thus also be achieved without running the risk of an electrical short circuit.

In a further refinement, the first electrical connection lead comprises a first connection lug made of sheet metal, and the second electrical connection lead comprises a second connection lug made of sheet metal.

Such connection lugs made of sheet metal are particularly suitable for simple electrical contacting of the switch. Since the connection leads or connection lugs are stabilized by the filler material, there is also no risk of them breaking off. In this respect, the two connection lugs can be designed at their free ends directly as plug-in connections, which further simplifies the electrical connection of the switch.

It is understood that the features mentioned above and those yet to be explained below can be used not only in the combination indicated in each case, but also in other combinations or in isolation, without departing from the spirit and scope of the present disclosure.

### BRIEF DESCRIPTION OF THE DRAWINGS

FIG. 1 is a schematic cross-sectional view of an embodiment of the temperature-dependent switch, with the switch in its closed state;

FIG. 2 is a schematic cross-sectional view of the switch shown in FIG. 1, with the switch in its open state; and

FIG. 3 is a schematic cross-sectional view of the switch shown in FIGS. 1 and 2 along the section line III-III indicated in FIG. 2.

### DESCRIPTION OF PREFERRED EMBODIMENTS

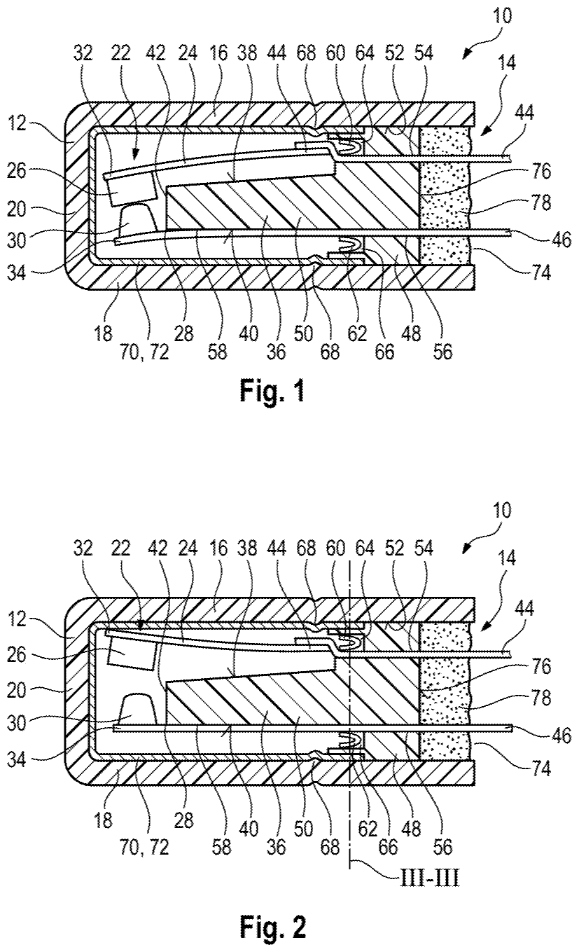

FIGS. 1 and 2 show a first embodiment of the switch in a schematic longitudinal sectional view. The switch is designated therein in its entirety by the reference numeral 10. FIG. 1 shows the closed state of the switch 10. FIG. 2 shows the open state of the switch 10.

The switch 10 comprises a cup-shaped or pocket-shaped switch housing 12, which has exclusively one open housing side 14. The remaining housing sides of the switch housing 12 are closed.

More precisely, the switch housing 12 comprises two closed and parallel longitudinal sides 16, 18 and three narrow sides extending between these longitudinal sides 16, 18 and transversely thereto, wherein in the longitudinal sectional views shown in FIGS. 1 and 2 only one of these narrow sides 20 is visible, namely the narrow side 20 which is opposite the open housing side 14.

The switch housing 12 is preferably made integrally of metal. Particularly preferably, the switch housing 12 is made of steel.

In the switch housing 12, a temperature-dependent switching mechanism 22 is arranged in an encapsulated manner. The temperature-dependent switching mechanism 22 comprises a first terminal strip 24 with a first contact element 26 arranged thereon, and a second terminal strip 28 with a second contact element 30 arranged thereon. The first contact element 26 is arranged in a region of a free end 32 of the first terminal strip 24, in other words near or adjacent to the free end 32 of the first terminal strip 24. The second contact element 30 is arranged in a region of a free end 34 of the second terminal strip 28, in other words near or adjacent to the free end 34 of the second terminal strip 28. The free front end 32 of the first terminal strip 24 as well as the free front end 34 of the second terminal strip 28 project freely into the interior of the switch housing 12 without directly abutting it.

In the closed state of the switch 10, the two contact elements 26, 30 are resiliently pressed against each other by the terminal strips 24, 28 (FIG. 1). The two terminal strips 24, 28, on which the contact elements 26, 30 are arranged, are carried by an insulating body 36. The first terminal strip 24 is arranged on a first side 38 of the insulating body 36 or faces a first side 38 of the insulating body 36. The second terminal strip 28 is arranged on a second side 40 of the insulating body 36 opposite the first side 38. However, both terminal strips 24, 28 project with their respective front free ends 32, 34 over a front end 42 of this insulating body 36, so that the two contact elements 26, 30 can touch each other in the closed state of the switch 10.

The first terminal strip 24 is preferably made of a bimetal or comprises at least such a bimetal. The second terminal strip 28 acts as a spring element, which is preferably made of a spring steel. Both terminal strips 24, 28 can be shaped differently when viewed in plan view. They are preferably tongue-shaped.

The first terminal strip 24 is joined in a materially bonded manner to a first connection lead 44 in the region of its rear end 44, which is opposite the front end 32. Preferably, the first terminal strip 24 is soldered to this first connection lead 44 of the switch 10. The first connection lead 44 is designed as a stable, uninsulated connection lug made of sheet metal. The first connection lead 44 extends out of the switch housing 12 at the open housing side 14.

The second terminal strip 28 is preferably configured integrally with a second connection lead 46 of the switch 10. The second terminal strip 28 is thus, in other words, integrally connected with the second connection lead 46. To put it another way, the second terminal strip 28 merges directly into the second connection lead 46. The second connection lead 46 is also guided out of the switch housing 12 at the open housing side 14.

The insulating body 36, which is preferably made of ceramic, keeps the two connection leads 44, 46 spaced apart from each other. The insulating body 36 thus serves, on the one hand, as a mechanical holder for the two connection leads 44, 46. On the other hand, the insulating body 36 provides for electrical insulation of the two connection leads 44, 46 from each other.

The insulating body 36 comprises a base section 48 as well as a cantilever section 50 which is integrally connected with this base section 48 and protrudes forward into the interior of the switch housing 12. The base section 48 of the insulating body 36 rests in a positive-locking manner against a cylindrical inner wall of the switch housing 12. The base section 48 of the insulating body 36 accordingly preferably also has a cylindrical outer contour.

The cantilever section 50 of the insulating body 36 protrudes forward from the base section 48 in the manner of a cantilever beam and projects freely into the interior of the switch housing 12. The front end 42, which closes off the insulating body 36 at the front, is arranged on this cantilever section 50. While a part of the second terminal strip 28 preferably abuts directly against this cantilever section 50 from the second side 40, the first terminal strip 24 is preferably spaced apart from the first side 38 of the cantilever section 50 in both the closed state and the open state of the switch 10.

In the base section 48, two through-openings 54, 56 are provided, which serve to guide the connection leads 44, 46 to the outside. The first connection lead 44 is guided through the first through-opening 54. The second connection lead 46 is guided through the second through-opening 56. The through-openings 54, 56 are each designed as through-holes, through which the respective connection lead 44, 46 is guided in a positive-locking manner. The two through-openings 54, 56 are each arranged spaced apart from the switch housing 12, so that the connection leads 44, 46 guided through the through-openings 54, 56 have no contact with the metal switch housing 12, which would otherwise lead to an electrical short circuit.

The cantilever section 50 further comprises a guide groove 58 extending in the longitudinal direction, in which the second terminal strip 28 is guided longitudinally. This guide groove 58 serves to guide the second terminal strip 28 and prevents it from shifting laterally relative to the insulating body 36. The position of the two terminal strips 24, 28 and the two connection leads 44, 46 relative to the insulating body 36 is, moreover, fixed by two spring elements 60, 62. The first spring element 60 is arranged in a first receiving pocket 64, which is provided in the base section 48 of the insulating body 36. This first spring element 60 resiliently clamps the first connection lead 44 to the insulating body 36. The second spring element 62 is arranged in a second receiving pocket 66, which is also provided on the base section 48 of the insulating body 36. This second spring element 62 resiliently clamps the second connection lead 46 to the insulating body 36. In principle, both receiving pockets 64, 66, as well as the spring elements 60, 62, could be arranged further forward, i.e., further to the left in FIGS. 1 and 2, so that the spring elements would then not press on the connection leads 44, 46, but directly on the terminal strips 24, 28 and would resiliently clamp them to the insulating body 36.

From FIGS. 1 and 2 it is further apparent that the switch housing 12 has an indentation or constriction 68. This indentation 68 can in principle be designed as an annular, circumferential constriction of the switch housing 12. However, the indentation 68 can also comprise individual pressure bosses arranged distributed along the circumference of the inner wall 52 of the switch housing 12. The indentation 68 essentially serves to regulate and pre-define the insertion depth of the insulating body 36. The indentation 68 serves, in other words, as a longitudinal stop for the base section 48 of the insulating body 36 and thus ensures a defined abutment of the insulating body 36 against the inner wall 52 of the switch housing 12.

The inner wall 52 of the switch housing 12 is further lined with a layer 70 of electrically insulating material. This layer 70 prevents an electrical short circuit between one of the two terminal strips 24, 28 and the switch housing 12. In particular, in the open state of the switch 10 shown in FIG. 2, the first terminal strip 24 comes very close to the inner wall 52 of the switch housing 12.

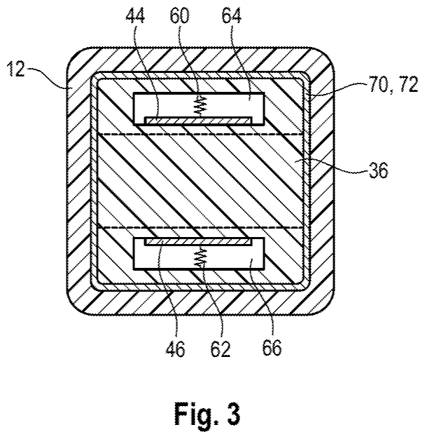

The electrically insulating layer 70 is, in the embodiment shown here, part of an insulating cap 72, which is inserted into the switch housing 12 and preferably rests in a positive-locking manner against the inner wall 52 of the switch housing 12. This insulating cap is preferably made of a heat-resistant insulating material, particularly preferably of actively drawn Nomex®. The insulating cap 72 is, as is particularly apparent from FIG. 3, clamped between the insulating body 36 and the switch housing 12, more precisely between the base section 48 of the insulating body 36 and the inner wall 52 of the switch housing 12, and is thereby fixed in its position.

The base section 48 of the insulating body 36, which rests in a positive-locking manner against the inner wall 52 of the switch housing 12, forms, in the region of the open housing side 14 of the switch housing 12, together with the inner wall 52 of the switch housing 12, a type of cup-shaped recess 74. The inner wall 52 of the switch housing 12 forms the peripheral wall of this cup-shaped recess 74. The outer side 76 of the insulating body 36 facing away from the interior of the switch housing 12 forms the bottom of the cup-shaped recess 74. A filler material 78 is introduced into this cup-shaped recess 74. This filler material 78 is preferably made of fused glass, for example molten glass granulate. The filler material 78 or the fused glass provides for a hermetically tight sealing of the open housing side 14 of the switch housing 12. At the same time, the filler material 78 provides for a materially bonded connection between the metal switch housing 12 and the ceramic insulating body 36. Moreover, the two connection leads 44, 46 are guided through this filler material 78 of fused glass, whereby the two connection leads 44, 46 are mechanically stabilized.

Overall, this results in a compactly designed switch 10, which is constructed to be comparatively pressure-stable due to its metal switch housing 12 and is hermetically sealed with the aid of the filler material 78 of fused glass. The temperature-dependent switching mechanism 22 arranged in the interior of the switch housing 12 is thus protected in the best possible way from external influences.

In the closed state of the switch 10 shown in FIG. 1, current flows from the first connection lead 44 via the first terminal strip 24 made of bimetal to the first contact element 26, from there to the second contact element 30 into the second terminal strip 28 and the second connection lead 46. The circuit is thus closed via the switch 10 in the closed state of the switch 10. If, starting from this situation, a temperature increase occurs beyond the switching temperature of the bimetal, be it through a temperature increase of the device to be protected by the switch 10 or through an increased current strength, the first terminal strip 24 snaps from its position shown in FIG. 1 into its position shown in FIG. 2 and thereby lifts the first contact element 26 off the second contact element 30. The previously closed circuit via the switch 10 is thus interrupted.

As already mentioned at the beginning, the switch 10 can be designed such that it is in its closed state shown in FIG. 1 below the response temperature of the bimetal and in its open state shown in FIG. 2 above the response temperature of the bimetal. This usual case is referred to as “normally closed”. In principle, however, the switch 10 can also be designed such that it is in its open state shown in FIG. 2 below the switching or response temperature of the bimetal and in its closed state shown in FIG. 1 above the switching or response temperature of the bimetal. This is referred to as “normally open”.

Furthermore, it is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A temperature-dependent switch, comprising:
a switch housing formed of metal and having a cup-shaped or pocket-shaped configuration, the switch housing defining an open housing side;
a first electrical connection lead extending from the switch housing;
a second electrical connection lead extending from the switch housing;
a temperature-dependent switching mechanism disposed in the switch housing and configured to switch in a temperature-dependent manner between a closed state, in which the switching mechanism establishes an electrically conductive connection between the first electrical connection lead and the second electrical connection lead, and an open state, in which the switching mechanism interrupts the electrically conductive connection, the temperature-dependent switching mechanism comprising:
a first terminal strip connected to or integrally formed with the first electrical connection lead, the first terminal strip having a free end extending into an interior of the switch housing and carrying a first contact element, and
a second terminal strip connected to or integrally formed with the second electrical connection lead, the second terminal strip having a free end extending into the interior of the switch housing and carrying a second contact element,
wherein the second contact element is biased into contact with the first contact element in the closed state and is spaced apart from the first contact element in the open state;
an insulating body supporting the temperature-dependent switching mechanism and electrically insulating the first terminal strip from the second terminal strip, the insulating body being disposed in the switch housing, the insulating body including:
a first through-opening through which the first electrical connection lead extends, and
a second through-opening through which the second electrical connection lead extends; and
a filler material sealing the open housing side of the switch housing in a gas-tight manner,
wherein the first electrical connection lead and the second electrical connection lead extend through the filler material.

2. The temperature-dependent switch of claim 1, wherein the filler material comprises a glass layer.

3. The temperature-dependent switch of claim 2, wherein the glass layer comprises fused glass.

4. The temperature-dependent switch of claim 1, wherein the insulating body is formed of ceramic.

5. The temperature-dependent switch of claim 1, wherein the insulating body is disposed within and retained in the switch housing closes the open housing side of the switch housing.

6. The temperature-dependent switch of claim 1, wherein the filler material is bonded to the insulating body and the switch housing.

7. The temperature-dependent switch of claim 1, wherein the switch housing and the insulating body define a cup-shaped recess that contains the filler material.

8. The temperature-dependent switch of claim 1, wherein the insulating body comprises a base section and a cantilever section extending from the base section, the base section being mechanically retained against an inner wall of the switch housing, and the cantilever section extending into an interior of the switch housing.

9. The temperature-dependent switch of claim 8, wherein the first terminal strip is disposed on a first side of the cantilever section and the second terminal strip is disposed on a second side of the cantilever section opposite the first side.

10. The temperature-dependent switch of claim 9, wherein the cantilever section comprises a guide groove, and the second terminal strip is mechanically retained in the guide groove.

11. The temperature-dependent switch of claim 9, wherein the first terminal strip has a free end extending into the switch housing and carrying the first contact element, the free end of the first terminal strip projecting beyond a front end of the cantilever section facing away from the base section.

12. The temperature-dependent switch of claim 11, wherein the second terminal strip has a free end extending into the switch housing and carrying the second contact element, the free end of the second terminal strip projecting beyond the front end of the cantilever section.

13. The temperature-dependent switch of claim 1, wherein the first terminal strip comprises a bimetal.

14. The temperature-dependent switch of claim 1, wherein the insulating body comprises a first receiving pocket, and a first spring element is disposed in the first receiving pocket and is configured to resiliently clamp at least one of the first terminal strip and the first electrical connection lead to the insulating body.

15. The temperature-dependent switch of claim 14, wherein the insulating body comprises a second receiving pocket, and a second spring element is disposed in the second receiving pocket and is configured to resiliently clamp at least one of the second terminal strip and the second electrical connection lead to the insulating body.

16. The temperature-dependent switch of claim 1, wherein an inner wall of the switch housing includes a layer of electrically insulating material facing the temperature-dependent switching mechanism.

17. The temperature-dependent switch of claim 16, wherein the layer of electrically insulating material is defined by an insulating cap clamped between the switch housing and the insulating body.

18. The temperature-dependent switch of claim 1, wherein the first electrical connection lead comprises a first connection lug formed of sheet metal, and the second electrical connection lead comprises a second connection lug formed of sheet metal.

19. The temperature-dependent switch of claim 1, wherein the filler material forms a hermetic seal between the switch housing and the insulating body.

20. The temperature-dependent switch of claim 1, wherein the filler material mechanically stabilizes the first and second electrical connection leads.
